(19) United States
(12) Patent Application Publication
(10) Pub. No.: US 2026/0287344 A1
(43) Pub. Date: Sep. 24, 2026

(54) BATTERY MEASURING APPARATUS AND CONTROLLING METHOD OF THE SAME

(71) Applicant: SK On Co., Ltd., Seoul (KR)

(72) Inventors: Hwan Cheol YOU, Daejeon (KR); Kyeong Tae PARK, Daejeon (KR); Ju Hwan LEE, Daejeon (KR); Gil Yong CHOI, Daejeon (KR); Yong Ki CHOI, Daejeon (KR)

(21) Appl. No.: 19/575,952

(22) Filed: Mar. 24, 2026

(30) Foreign Application Priority Data
Mar. 24, 2025 (KR) 10-2025-0037472

(51) Int. Cl. G01B 21/08; H01M 10/42

(52) U.S. Cl. CPC G01B 21/08; H01M 10/4285

(57) ABSTRACT

A battery measuring apparatus configured to measure a length of a battery cell including an electrode assembly in which a first electrode, a second electrode, and a separator positioned between the first electrode and the second electrode are stacked along a predetermined stacking direction and a case which accommodates the electrode assembly therein is provided. The battery measuring apparatus includes a first plate portion configured to support the battery cell along the stacking direction, a second plate portion movably provided along the stacking direction and configured to press the case between the first plate portion and the second plate portion at a predetermined pressure, and a thickness measuring unit spaced apart from the first plate portion and the second plate portion, independently supported, and configured to measure a thickness, which is the length of the battery cell along the stacking direction.

### CROSS-REFERENCE TO RELATED PATENT APPLICATION

The present disclosure claims priority under 35 U.S.C. § 119(a) to Korean patent application number 10-2025-0037472, filed on March 24, 2025, the entire disclosure of which is incorporated herein by reference.

### BACKGROUND OF THE INVENTION

### 1. Field

Various embodiments of the present disclosure generally relate to a battery measuring apparatus and a controlling method of the same, and more particularly, to a battery measuring apparatus for measuring the thickness of a battery cell and a controlling method of the same.

### 2. Description of the Related Art

In mounting or detaching a plurality of battery cells into or from a limited space, such as a battery module or a battery pack, dimensional accuracy of the battery cells (e.g., lithium-ion batteries) is required. If the dimensions of the battery cells are not accurate, a step difference or a gap may occur, which may result in defects in a battery assembly.

To achieve dimensional accuracy, after the battery cells are manufactured, the dimensions of the battery cells need to be measured in consideration of pressure that may be applied in an environment in which the battery cells are used, within a range that does not cause damage to the battery cells. Conventional battery measuring apparatuses use a contact displacement sensor that measures the thickness of a battery cell by contacting the battery cell while the battery cell is pressed, but there is a need to reduce the time required for measuring the thickness of the battery cell to improve the productivity of the battery cell.

### SUMMARY OF THE INVENTION

According to an aspect of the present disclosure, an object is to improve the productivity of a battery cell.

According to another aspect of the present disclosure, an object is to reduce the time required for measuring the thickness of the battery cell.

According to still another aspect of the present disclosure, an object is to improve the accuracy in measuring the thickness of the battery cell.

According to yet another aspect of the present disclosure, an object is to accurately measure the thickness of the battery cell even in the presence of vibrations and impacts.

The battery cell, which is manufactured using a battery measuring apparatus and a controlling method thereof according to the present disclosure, can be widely applied in the green technology fields such as electric vehicles, battery charging stations, energy storage systems (ESSs), and other technologies using batteries such as photovoltaics and wind power. Furthermore, the battery cell, which is manufactured using the battery measuring apparatus and the controlling method thereof according to the present disclosure, may be used for eco-friendly mobility, including electric and hybrid vehicles, to reduce air pollution and greenhouse gas emissions to prevent or mitigate climate change.

In a battery measuring apparatus configured to measure a length of a battery cell including an electrode assembly in which a first electrode, a second electrode, and a separator positioned between the first electrode and the second electrode are stacked along a predetermined stacking direction and a case which accommodates the electrode assembly therein, the battery measuring apparatus according to the present disclosure may include a first plate portion configured to support the battery cell along the stacking direction, a second plate portion movably provided along the stacking direction and configured to press the case between the first plate portion and the second plate portion at a predetermined pressure, and a thickness measuring unit spaced apart from the first plate portion and the second plate portion, independently supported, and configured to measure a thickness, which is the length of the battery cell along the stacking direction.

In an embodiment, the battery measuring apparatus according to the present disclosure may further include a cell sensing unit disposed at an outer side of the first plate portion and the second plate portion and configured to sense whether the battery cell is placed in a predetermined placement area of the first plate portion.

In an embodiment, the cell sensing unit may include a plurality of cell sensing units, and the plurality of cell sensing units may be disposed diagonally with the battery cell interposed therebetween.

In an embodiment, the battery measuring apparatus according to the present disclosure may further include a pressure sensing unit disposed on the second plate portion and configured to measure a pressure applied by the second plate portion to the battery cell.

In an embodiment, the battery measuring apparatus according to the present disclosure may further include a blower unit disposed at one side of the first plate portion and the second plate portion, spaced apart therefrom, and configured to move air toward the first plate portion and the second plate portion.

In an embodiment, the blower unit may include a blower pipe configured in a shape of a pipe through which air travels, a through-hole penetrating the blower pipe, and a nozzle disposed in the through-hole and configured to discharge the air traveling through the blower pipe toward the first plate portion and the second plate portion.

In an embodiment, the thickness measuring unit may include a plurality of thickness measuring units and configured to measure the thickness of the battery cell in different regions of the battery cell.

In an embodiment, the plurality of thickness measuring units may be disposed at a same height.

In an embodiment, the thickness measuring unit may be a non-contact displacement sensor.

In an embodiment, the battery measuring apparatus according to the present disclosure may further include a transfer unit configured to transfer the battery cell to a predetermined placement area of the first plate portion, and to transfer the battery cell out after measurement by the thickness measuring unit.

In an embodiment, the transfer unit may be configured to transfer the battery cell introduced into a predetermined inlet area to the placement area by a pick-and-place method, and to transfer the battery cell from the placement area to a predetermined outlet area after the measurement by the thickness measuring unit is completed.

In an embodiment, the first plate portion and the second plate portion may each be coated on a surface contacting the battery cell.

In an embodiment, resolution of the thickness measuring unit may be less than or equal to 0.5 μm.

In a controlling method of a battery measuring apparatus including a first plate portion configured to support a battery cell and a second plate portion facing the first plate portion and movable in a direction toward or away from the first plate portion to press the battery cell at a predetermined pressure, the controlling method according to the present disclosure may include: placing the battery cell in a predetermined placement area of the first plate portion via a transfer unit disposed spaced apart from an outer side of the first plate portion and the second plate portion; pressing the battery cell at the predetermined pressure by moving the second plate portion toward the first plate portion; and measuring a thickness of the battery cell under the predetermined pressure.

In an embodiment, in pressing the battery cell, in the controlling method according to the present disclosure, a predetermined gap between the first plate portion and the second plate portion may be maintained.

According to an embodiment of the present disclosure, the productivity of a battery cell may be improved.

According to another embodiment of the present disclosure, the time required for measuring the thickness of the battery cell may be reduced.

According to still another embodiment of the present disclosure, the accuracy in measuring the thickness of the battery cell may be improved.

According to yet another aspect of the present disclosure, the thickness of the battery cell may be measured accurately even in the presence of vibrations and impacts.

### BRIEF DESCRIPTION OF THE DRAWINGS

FIG. 1 illustrates an example of a battery cell;

FIG. 2 illustrates an example of a battery measuring apparatus according to the present disclosure;

FIG. 3 illustrates a cross section of a battery measuring apparatus according to the present disclosure;

FIG. 4 is a control block diagram of a battery measuring apparatus according to the present disclosure; and

FIG. 5 is a flowchart illustrating a controlling method of a battery measuring apparatus according to the present disclosure.

### DETAILED DESCRIPTION

Hereinafter, example embodiments of the present disclosure will be described in detail with reference to the accompanying drawings. In the present disclosure, the terms "battery," "secondary battery," and "cell" are used interchangeably with the term "battery cell."

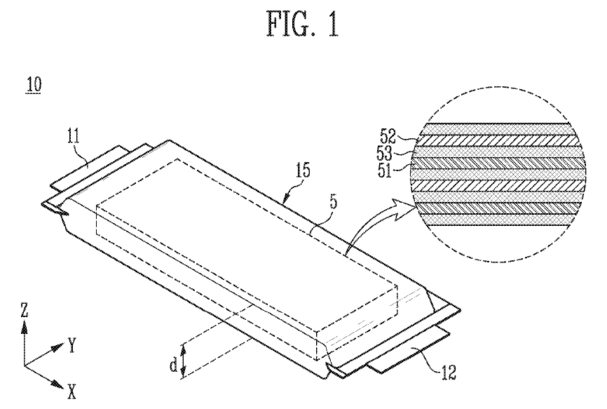

FIG. 1 illustrates an example of a battery cell 10.

Referring to FIG. 1, the battery cell 10 may include a case 15 that includes an electrode assembly 5 therein.

Further, the battery cell 10 may include terminal portions 11 and 12 that protrude outwardly from the case 15 in electrical connection with the electrode assembly 5.

The electrode assembly 5 may include a first electrode 51, a second electrode 52 having a different electrical polarity from the first electrode 51, and a separator 53 electrically separating the first electrode 51 and the second electrode 52 between the first electrode 51 and the second electrode 52. The electrode assembly 5 may be in the form in which the first electrode 51, the separator 53, and the second electrode 52 are stacked along a predetermined stacking direction (a Z direction).

The terminal portions 11 and 12 may include a first terminal portion 11 coupled to the first electrode 51 and a second terminal portion 12 coupled to the second electrode 52. While FIG. 1 illustrates an example in which the first terminal portion 11 and the second terminal portion 12 protrude in opposite directions from each other, the battery cell 10 is not limited thereto. That is, the first terminal portion 11 and the second terminal portion 12 may protrude in the same direction. Furthermore, the first terminal portion 11 and the second terminal portion 12 may include a plurality of first terminal portions and a plurality of second terminal portions.

The case 15 may be formed in the form of a flexible film, which can be deformed in response to internal or external pressure. Alternatively, the case 15 may be formed of a stiff material.

A thickness d of the battery cell 10 may refer to a length of the battery cell 10 along the stacking direction of the first electrode 51 and the second electrode 52. Thus, the thickness d of the battery cell 10 may be a thickness of the case 15.

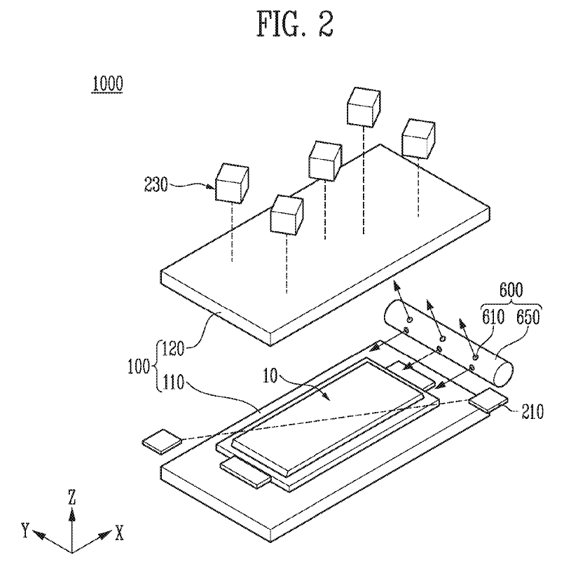

FIG. 2 illustrates an example of a battery measuring apparatus 1000 according to the present disclosure.

In general, the battery cell 10 may be used in the form of a stack in which a plurality of battery cells are stacked. The stack may be pressed from both sides thereof to prevent swelling of the battery cell 10. Accordingly, the dimensions of the battery cell 10 may vary between a pressed state and a released state. The thickness of the battery cell 10 needs to be measured under a predetermined pressure, taking into account the environment in which the battery cell 10 is used.

To this end, the battery measuring apparatus 1000 according to the present disclosure may include a first plate portion 110 supporting the battery cell 10 along the stacking direction, a second plate portion 120 movably provided along the stacking direction and pressing the case 15 between the first plate portion 110 and the second plate portion 120 at a predetermined pressure, and a thickness measuring unit 230 spaced apart from the first plate portion 110 and the second plate portion 120, independently supported, and measuring the thickness, which is the length of the battery cell 10, along the stacking direction.

The first plate portion 110 may support the battery cell 10. The battery measuring apparatus 1000 according to the present disclosure may place the battery cell 10 in a predetermined placement area PA of the first plate portion 110.

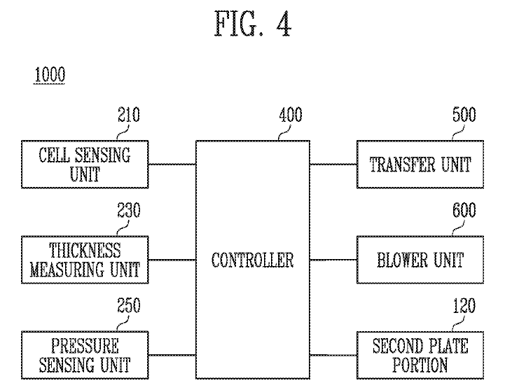

For this purpose, the battery measuring apparatus 1000 according to the present disclosure may further include a transfer unit (500, see FIG. 4) transferring the battery cell 10 to the predetermined placement area PA of the first plate portion 110, and transferring the battery cell 10 to the outside after measurement by the thickness measuring unit 230.

The second plate portion 120 may be movably provided in a direction toward or away from the first plate portion 110 in order to press the battery cell 10 that is positioned between the first plate portion 110 and the second plate portion 120 at a predetermined pressure.

For example, the second plate portion 120 may be moved by a piston, and the thrust applied to the piston may be 1000 kg·f, such that the pressure exerted by the second plate portion 120 on the battery cell 10 may be greater than or equal to 0.05 MPa and less than or equal to 0.2 MPa.

In another example, the pressure exerted by the second plate portion 120 on the battery cell 10 may be 1.73 kgf/cm³.

Furthermore, the first plate portion 110 and the second plate portion 120 may be formed of a metal material having a certain thickness or more, so that the first plate portion 110 and the second plate portion 120 are not to bend or deform to support and press the battery cell 10.

For example, the first plate portion 110 and the second plate portion 120 may have a thickness of 25 mm or more. Furthermore, the first plate portion 110 and the second plate portion 120 may be formed of aluminum.

In addition, the battery cell 10 may be damaged when the battery cell 10 is placed in the placement area PA or when the battery cell 10 is pressed. To prevent or mitigate such damage, the first plate portion 110 and the second plate portion 120 may each be coated on a surface contacting the battery cell 10.

For example, when the first plate portion 110 and the second plate portion 120 formed of aluminum, the surface of each of the first plate portion 110 and the second plate portion 120 which contacts the battery cell 10 may be anodized, which also prevents or mitigates oxidation and corrosion of the first plate portion 110 and the second plate portion 120. Furthermore, by hard anodizing, the hardness, corrosion resistance, wear resistance, and electrical insulation of the surface of each the first plate portion 110 and the second plate portion 120 which contacts the battery cell 10 may be improved.

When the second plate portion 120 is moved toward the first plate portion 110 and presses the battery cell 10, the first plate portion 110 and the second plate portion 120 may maintain a predetermined gap while contacting the battery cell 10.

The gap may be less than or equal to the thickness of the battery cell 10. Preferably, the gap may be less than the thickness of the battery cell 10, which is to increase the contact time between the first plate portion 110 and the second plate portion 120 and the battery cell 10.

The thickness measuring unit 230 may be spaced apart from the first plate portion 110 and disposed independently. Being disposed independently may mean that the thickness measuring unit 230 is disposed separately from other components that cause vibrations or impacts, including the first plate portion 110 and the second plate portion 120. This is to increase the accuracy of the measurement by the thickness measuring unit 230.

The resolution (or accuracy) of the thickness measuring unit 230 may be less than or equal to a predetermined resolution value.

For example, the resolution (or accuracy) of the thickness measuring unit 230 may be less than or equal to 0.5 μm. That is, the unit of measurement of the length measured by the thickness measuring unit 230 is less than or equal to 0.5 μm. However, this is only an example, and the resolution of the thickness measuring unit 230 may be set differently.

For example, the thickness measuring unit 230 may be a non-contact displacement sensor. The non-contact displacement sensor may measure the thickness of the battery cell 10 using light (or laser), eddy current, or ultrasound.

For example, by measuring the distance from the thickness measuring unit 230 to the second plate portion 120 pressing the battery cell 10, the thickness of the battery cell 10 may be calculated because the distance from the thickness measuring unit 230 to the first plate portion 110 is fixed.

The thickness measuring unit 230 may include a plurality of thickness measuring units 230, so that the thickness of the battery cell 10 may be measured in different areas of the battery cell 10, which is to more accurately measure the thickness of the battery cell 10, as the thickness of the battery cell 10 may vary by region.

In addition, the plurality of thickness measuring units 230 may be disposed at the same height. Because the plurality of thickness measuring units 230 are fixed at the same height, an error due to the position of the plurality of thickness measuring units 230 may be minimized or reduced.

The battery measuring apparatus 1000 according to the present disclosure may further include a cell sensing unit 210 disposed at an outer side of the first plate portion 110 and the second plate portion 120 and sensing whether the battery cell is placed in the predetermined placement area PA of the first plate portion 110.

The cell sensing unit 210 may verify whether the battery cell 10 to be measured is properly placed in the placement area PA.

For example, the cell sensing unit 210 may be provided as an optical sensor, and when the first terminal portion 11 and the second terminal portion 12 block light emitted from the cell sensing unit 210, a controller (400, see FIG. 4) may determine, via the cell sensing unit 210, that the battery cell 10 is placed in the placement area PA.

To this end, the cell sensing unit 210 may include the plurality of cell sensing units 210, and the plurality of cell sensing units 210 may be disposed diagonally with the battery cell 10 interposed therebetween. That is, at least two cell sensing units 210 are provided to sense the first terminal portion 11 and the second terminal portion 12, and the plurality of cell sensing units 210 may be disposed diagonally to account for a case where the battery cell 10 is oriented obliquely across the placement area PA.

Alternatively, the cell sensing unit 210 may verify whether the battery cell 10 is placed in the placement area PA by using a vision system.

In an embodiment, the battery measuring apparatus 1000 according to the present disclosure may further include a blower unit 600 disposed at one side of the first plate portion 110 and the second plate portion 120, spaced apart therefrom, and moving air toward the first plate portion 110 and the second plate portion 120.

The blower unit 600 is provided to remove foreign matter that may adhere to the surface of each of the first plate portion 110 and the second plate portion 120 which contacts the battery cell 10, in order to accurately measure the thickness of the battery cell 10.

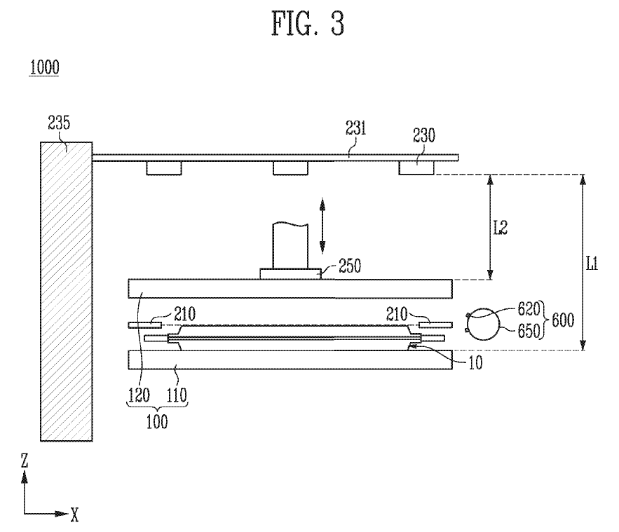

For example, the blower unit 600 may include a blower pipe 650 configured in the shape of a pipe through which air travels, a through-hole 610 penetrating the blower pipe 650, and a nozzle (620, see FIG. 3) disposed in the through-hole 610 and discharging air traveling through the blower pipe 650 toward the first plate portion 110 and the second plate portion 120.

The blower unit 600 may further include a blower motor (not shown) transferring air through the blower pipe 650, and a blower fan (not shown) rotated by the blower motor.

Because the blower unit 600 also causes vibrations, the thickness measuring unit 230 may also be spaced apart from the blower unit 600 and disposed independently.

FIG. 3 illustrates a cross section of the battery measuring apparatus 1000 according to the present disclosure.

Referring to FIGS. 1 to 3, regarding the battery measuring apparatus 1000 measuring the length of the battery cell 10 which includes the electrode assembly 5 in which the first electrode 51, the second electrode 52, and the separator 53 positioned between the first electrode 51 and the second electrode 52 are stacked along the predetermined stacking direction, and the case 15 which accommodates the electrode assembly 5 therein, the battery measuring apparatus 1000 according to the present disclosure includes the first plate portion 110 supporting the case 15 along the stacking direction, the second plate portion 120 movably provided along the stacking direction and pressing the case 15 between the first plate portion 110 and the second plate portion 120 at a predetermined pressure, and the thickness measuring unit 230 spaced apart from the first plate portion 110 and the second plate portion 120, independently supported, and measuring the thickness, which is the length of the battery cell 10 along the stacking direction.

As described above, the thickness measuring unit 230 may be independently supported and disposed. To this end, referring to FIG. 3, the thickness measuring unit 230 may be mounted on a separate blanket 231 (or support arm) and supported by a separate fixing member 235.

Furthermore, as described above, because a distance L1 to the first plate portion 110 from the thickness measuring unit 230 and the thickness of the second plate portion 120 are fixed values, when the thickness measuring unit 230 measures a variable distance to the second plate portion 120 from the thickness measuring unit 230, the controller (400, see FIG. 4) to be described below may calculate the thickness of the battery cell 10.

The blower unit 600 may more effectively remove foreign matter from the first plate portion 110 and the second plate portion 120 via the nozzle 620 that discharges air releasing from the blower pipe 650 toward the first plate portion 110 and the second plate portion 120.

Before or after the battery cell 10 is placed in the placement area PA by the transfer unit (500, see FIG. 4) to be described below, the controller 400 may control the blower unit 600 to discharge air transferred through the blower pipe 650 toward the first plate portion 110 and the second plate portion 120.

Alternatively, the blower unit 600 may continuously discharge air transferred through the blower pipe 650 toward the first plate portion 110 and the second plate portion 120.

In addition, the battery measuring apparatus 1000 according to the present disclosure may further include a pressure sensing unit 250 disposed on the second plate portion 120 and measuring the pressure applied by the second plate portion 120 to the battery cell 10.

For example, the pressure sensing unit 250 may be a load cell. Through the pressure sensing unit 250, the controller may measure a pressure (or the predetermined pressure) that the second plate portion 120 applies to the battery cell 10.

When the pressure measured via the pressure sensing unit 250 reaches the predetermined pressure, the controller 400 may stop the second plate portion 120 from moving and maintain a predetermined gap between the first plate portion 110 and the second plate portion 120.

FIG. 4 is a control block diagram of the battery measuring apparatus 1000 according to the present disclosure.

The battery measuring apparatus 1000 according to the present disclosure may include the controller 400 measuring the thickness of the battery cell 10 via the thickness measuring unit 230 and controlling the movement of the second plate portion 120.

Further, the controller 400 may control the blower unit 600, the pressure sensing unit 250, and the cell sensing unit 210.

The controller 400 may also control a communication unit (not shown) for exchanging electrical signals with the outside, and an input/output unit (not shown) receiving commands from the workplace and outputting a status or result accordingly.

The battery measuring apparatus 1000 according to the present disclosure may further include the transfer unit 500 transferring the battery cell 10 to the predetermined placement area PA of the first plate portion 110, and transferring the battery cell 10 to the outside after measurement by the thickness measuring unit 230.

Further, the controller 400 may control the transfer unit 500.

The battery measuring apparatus 1000 according to the present disclosure may further include an inlet area (not shown), which is an area where the battery cell 10 which is introduced for measurement stands by, and an outlet area (not shown), which is an area where the battery cell 10 which have been measured in the placement area PA is stored to be transferred to the next process.

In other words, the transfer unit 500 may transfer the battery cell 10 introduced into the predetermined inlet area to the placement area PA by a pick-and-place method, and then, after the measurement by the thickness measuring unit 230 is completed, transfer the battery cell 10 from the placement area PA to the predetermined outlet area.

However, this is only an example, and the transfer unit 500 may transfer the battery cell 10 by other methods (e.g., a conveyor belt).

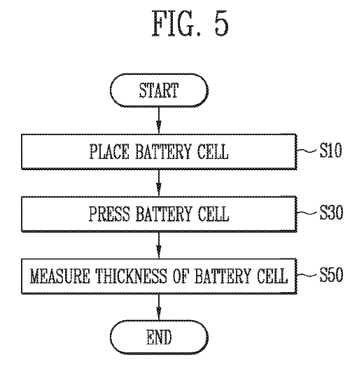

FIG. 5 is a flowchart illustrating a controlling method of the battery measuring apparatus 1000 according to the present disclosure.

The controlling method of the battery measuring apparatus 1000 according to the present disclosure may include placing the battery cell 10 in the predetermined placement area PA of the first plate portion 110 via the transfer unit 500 disposed spaced apart from an outer side of the first plate portion 110 and the second plate portion 120 (S10), pressing the battery cell 10 at a predetermined pressure by moving the second plate portion 120 toward the first plate portion 110 (S30), and measuring the thickness of the battery cell 10 under the predetermined pressure (S50).

In placing the battery cell 10 in the placement area PA of the first plate portion 110 (S10), in the controlling method of the battery measuring apparatus 1000 according to the present disclosure, the battery cell 10 may be transferred from the inlet area to the placement area via the transfer unit 500 and may be placed in the placement area PA.

In the controlling method of the battery measuring apparatus 1000 according to the present disclosure, it may be verified whether the battery cell 10 is placed in the placement area PA via the cell sensing unit 210.

Thereafter, in the controlling method of the battery measuring apparatus 1000 according to the present disclosure, in pressurizing the battery cell 10 (S30), a predetermined gap between the first plate portion 110 and the second plate portion 120 may be maintained.

In the controlling method of the battery measuring apparatus 1000 according to the present disclosure, the second plate portion 120 may be moved toward the first plate portion 110 to press the battery cell 10. In the controlling method of the battery measuring apparatus 1000 according to the present disclosure, the second plate portion 120 may be moved until the pressure applied to the battery cell 10 reaches the predetermined pressure.

In the controlling method of the battery measuring apparatus 1000 according to the present disclosure, it may be verified whether the predetermined pressure is reached through the pressure sensing unit 250.

Thereafter, in the controlling method of the battery measuring apparatus 1000 according to the present disclosure, measuring the thickness of the battery cell 10 under the predetermined pressure (S50) may be performed.

Because the thickness measuring unit 230 may be spaced apart from the battery cell 10 and may measure the thickness of the battery cell 10 in a non-contact manner, the product per minute (PPM) of the battery cell 10 may be increased in a manufacturing system including the battery measuring apparatus 1000.

In the controlling method of the battery measuring apparatus 1000 according to the present disclosure, after performing measuring the thickness of the battery cell 10 under the predetermined pressure (S50), the battery cell 10 may be transferred from the placement area PA to the outlet area via the transfer unit 500. Then, in the controlling method of the battery measuring apparatus 1000 according to the present disclosure, a different battery cell 10 may be placed in the placement area PA via the transfer unit 500 and then the thickness of the different battery cell 10 may be measured. As described above, in the controlling method of the battery measuring apparatus 1000 according to the present disclosure, placing the battery cell 10 (S10), pressing the battery cell 10 (S30), and measuring the thickness of the battery cell 10 (S50) may be repeatedly performed.

The present disclosure may be implemented in various forms, and the scope of the present disclosure is not limited to the embodiments described above. Accordingly, any modified embodiments that include elements of the appended claims of the present disclosure should be construed as falling within the scope of the present disclosure.

What is claimed is:

1. A battery measuring apparatus configured to measure a length of a battery cell comprising an electrode assembly in which a first electrode, a second electrode, and a separator positioned between the first electrode and the second electrode are stacked along a predetermined stacking direction and a case which accommodates the electrode assembly therein, the battery measuring apparatus comprises:
a first plate portion configured to support the battery cell along the stacking direction;
a second plate portion movably provided along the stacking direction and configured to press the case between the first plate portion and the second plate portion at a predetermined pressure; and
a thickness measuring unit spaced apart from the first plate portion and the second plate portion, independently supported, and configured to measure a thickness, which is the length of the battery cell along the stacking direction.

2. The battery measuring apparatus of claim 1, further comprising a cell sensing unit disposed at an outer side of the first plate portion and the second plate portion and configured to sense whether the battery cell is placed in a predetermined placement area of the first plate portion.

3. The battery measuring apparatus of claim 2, wherein the cell sensing unit includes a plurality of cell sensing units, and
wherein the plurality of cell sensing units are disposed diagonally with the battery cell interposed therebetween.

4. The battery measuring apparatus of claim 1, further comprising a pressure sensing unit disposed on the second plate portion and configured to measure a pressure applied by the second plate portion to the battery cell.

5. The battery measuring apparatus of claim 1, further comprising a blower unit disposed at one side of the first plate portion and the second plate portion, spaced apart therefrom, and configured to move air toward the first plate portion and the second plate portion.

6. The battery measuring apparatus of claim 5, wherein the blower unit comprises:
a blower pipe configured in a shape of a pipe through which air travels;
a through-hole penetrating the blower pipe; and
a nozzle disposed in the through-hole and configured to discharge the air traveling through the blower pipe toward the first plate portion and the second plate portion.

7. The battery measuring apparatus of claim 1, wherein the thickness measuring unit includes a plurality of thickness measuring units and configured to measure the thickness of the battery cell in different regions of the battery cell.

8. The battery measuring apparatus of claim 7, wherein the plurality of thickness measuring units are disposed at a same height.

9. The battery measuring apparatus of claim 1, wherein the thickness measuring unit is a non-contact displacement sensor.

10. The battery measuring apparatus of claim 1, further comprising a transfer unit configured to transfer the battery cell to a predetermined placement area of the first plate portion, and to transfer the battery cell out after measurement by the thickness measuring unit.

11. The battery measuring apparatus of claim 10, wherein the transfer unit is configured to transfer the battery cell introduced into a predetermined inlet area to the placement area by a pick-and-place method, and to transfer the battery cell from the placement area to a predetermined outlet area after the measurement by the thickness measuring unit is completed.

12. The battery measuring apparatus of claim 1, wherein the first plate portion and the second plate portion are each coated on a surface contacting the battery cell.

13. The battery measuring apparatus of claim 1, wherein resolution of the thickness measuring unit is less than or equal to 0.5 μm.

14. A controlling method of a battery measuring apparatus comprising a first plate portion configured to support a battery cell and a second plate portion facing the first plate portion and movable in a direction toward or away from the first plate portion to press the battery cell at a predetermined pressure, the method comprising:
placing the battery cell in a predetermined placement area of the first plate portion via a transfer unit disposed spaced apart from an outer side of the first plate portion and the second plate portion;
pressing the battery cell at the predetermined pressure by moving the second plate portion toward the first plate portion; and
measuring a thickness of the battery cell under the predetermined pressure.

15. The method of claim 14, wherein pressing the battery cell includes maintaining a predetermined gap between the first plate portion and the second plate portion.
